(19) United States
(12) Patent Application Publication
(10) Pub. No.: US 2017/0240714 A1
(43) Pub. Date: Aug. 24, 2017

(54) A PROCESS FOR PRODUCING A COMPOSITE ARTICLE

(71) Applicant: Hexcel Composites Limited, Duxford (GB)

(72) Inventors: Asher Ahmed, London (GB); Chris Harrington, Duxford (GB); Nicholas Verge, Duxford (GB)

(21) Appl. No.: 15/516,682

(22) PCT Filed: Oct. 21, 2015
(86) PCT No.: PCT/EP2015/074424

§ 371 Date: Apr. 4, 2017

(30) Foreign Application Priority Data
Oct. 21, 2014 (GB) 1418679.5

(51) Int. Cl. C08J 5/24; B29C 70/38; B29C 35/08; C08J 7/12; B29C 35/02

(52) U.S. Cl. CPC C08J 5/24; C08J 7/123; B29C 35/02; B29C 35/0222; B29C 35/0805; B29C 70/386; C08J 2363/00; B29C 2035/0822; B29C 2035/0827

(57) ABSTRACT

Process for producing a composite material comprising depositing a prepreg containing a radiation initiated curing agent onto a mould using automated apparatus and applying heat and second source radiation to at least partially cure the prepreg at least simultaneously with the deposition of the prepreg. Also epoxy resin formulations of a mixture of a liquid epoxy resin and a solid or semi-solid epoxy resin containing a photoinitiator are used as the matrix in prepregs which are cured or partially cured by radiation to avoid the need for thermal cure in an oven. The formulation is particularly useful in the production of wind turbine blades especially in an automated process. Additionally an automated tape laying apparatus comprising compaction device, a heat source and a second radiation source.

The present invention relates to a curable resin formulation that may be used as the matrix in the production of fibre reinforced composites and in particular is concerned with a resin formulation that can be at least partially cured without the need to heat the prepreg in an oven to effect the degree of cure. The invention is also concerned with the use of such a resin formulation in the production of prepregs, in the production of at least partially cured prepregs without the use of an oven or autoclave, in the partially cured prepregs themselves and also in finished articles obtained from such prepregs in the fully cured state.

The term prepreg is used to describe a fibrous material embedded in a matrix of a curable resin.

Articles that are manufactured from prepregs are becoming larger and more complex in shape. For example, prepregs are now used in the manufacture of wind turbine blades and in aircraft fuselages both of which are becoming larger to suit modern day needs. Traditionally the prepregs used in such manufacture have comprised fibrous material such as glass, carbon or aramid fibre embedded in a matrix of a thermocurable resin. Typically the article has been produced by laying up (superimposing) several prepreg layers in a mould where they are heated in an oven to cure the resin formulation.

In these earlier processes the prepreg may be prepared prior to laying up the prepreg in the mould or the fibrous material may be laid up dry in the mould and impregnated in the mould by infusion of the resin. Whichever technique is used for laying up the resin formulation employed as the matrix is thermocurable, typically comprising a thermosetting resin such as an epoxy resin or a polyester resin containing a thermally activated curing agent. With the increasing size of the mouldings this has not only required large moulds but it also requires large ovens and slow heating rates to ensure adequate and uniform heating of the laid up prepregs to produce the finished articles. The tooling costs have therefore increased.

The curing of the thermocurable resins typically requires a precise heating cycle in order to get the desired degree of cure of the resin throughout the prepreg or stack of prepregs. The production of large articles can require long cure times and/or high curing temperatures. This is difficult to achieve when employing large convection based ovens and also requires expensive tooling. Additionally, the thermocuring techniques currently used for the production of these larger articles and/or articles of a more complex shape typically involves hand lay-up of the prepregs in the mould which is laborious and can lead to irregularities through the article.

The lay-up of large articles is time consuming and requires a large amount of man-hours. Large articles also require very long cure times to cure the resin whilst managing exothermic heat release, sometimes cure times can be more than a couple of days. This limits the rate of production of such articles and also has an associated increase of manufacturing costs.

The long cure times also mean that large articles which are cured in the conventional manner require a large amount of energy to produce. This is because the entire lay-up is heated at the same time until the entire article is cured; using far more energy is than would otherwise be needed to cure.

In conventional processes, the mould is occupied for both lay-up and cure, and as discussed above these are lengthy processes. The mould is only ready for re-use once cure has completed, the article removed and the mould surface prepared to receive the next lay-up. Therefore using conventional lay-up and cure methods, the only way to increase production rates is to invest in additional moulds. Moulds are expensive and represent a significant proportion of the cost of producing large articles, especially moulds that are adapted to withstand oven cure temperatures.

United States Patent Publication 2012/0138223 discloses the use of radiation curing of resins in prepregs used in the manufacture of wind turbine blades. It discloses the lay-up of multiple plies of prepreg to form a stack, the stack is then heated using infra-red radiation and cured using ultra violet radiation. If a thicker article is required a subsequent stack can be built on top of the cured stack and cured in the same manner. Such a process involves separate lay-up and cure stages which is time consuming. In addition, the layers at the bottom of the stack receive IR and UV radiation at a lower rate than the layers at the top of the stack, which means either variable cured properties exist through the stack or surplus energy is delivered to the top layers until sufficient radiation reaches the lower layers. Thus a process of this nature is both time and energy inefficient.

The present invention aims to solve any of the above described problems and/or to provide improvements generally.

According to the invention there is provided a use, apparatus and a process as defined in any one of the accompanying claims.

The invention further provides the use of a resin formulation comprising a mixture of a liquid epoxy resin and a solid epoxy resin and a photoinitiator for the cure of the resin in a prepreg comprising a fibrous material impregnated with the resin formulation to enable at least partial cure of the prepreg without the use of an oven.

The present invention provides a resin formulation that can be used in the production of large articles from prepregs without the need for large ovens to provide at least the initial cure of a stack of prepregs.

Resin formulations that can be cured by means other than heat are known, and in particular it is known that resin formulations can be cured by radiation, such as ultra violet light. However, we have found that the use of a resin formulation as in this invention as a matrix in prepregs can in addition to avoiding the need for large ovens, enable automatic lay-up and curing of the prepreg; particularly in the production of large articles such as wind turbine blades and components of an aircraft fuselage.

In an aspect of the present invention there is a process for the production of a partially or fully cured composite article. The process comprising depositing individual layers of prepreg onto a mould surface or onto other layers of prepreg. Heat and a second form of radiation are applied to the prepreg during and/or immediately following deposition to at least partially cure the deposited prepreg.

In an aspect of the present invention there is provided an automated tape laying apparatus for automated deposition and simultaneous partial cure of prepreg, the apparatus comprising a compaction device, a heat source, and a second radiation source. The apparatus being suitable for use with the prepreg and process of the present invention.

In an aspect of the present invention there is provided a prepreg capable of at least partial cure without the use of an oven, comprising a resin and a fibrous material impregnated with the resin, the resin further comprising a mixture of a liquid epoxy resin, a solid epoxy resin and at least one radical initiator, preferably a photoinitiator and optionally a radical (photo) cure accelerator. The prepreg is suitable for use with the automated tape laying apparatus and process of the present invention.

In a preferred embodiment of the present invention deposition of the prepreg is performed by automatic tape laying (ATL) or automatic fibre placement (AFP) apparatus. This ensures a uniform and reproducible placement of prepreg, with the fibrous reinforcement being highly aligned. This in turn results in articles being produced with improved mechanical properties. It is envisioned that other known methods of lay-up are compatible with the present invention such as filament winding.

In an aspect of the present invention there is a process of the producing a partially or fully cured composite article wherein as prepregs are deposited they are heated by an infra-red (IR) or heat source and exposed to a second radiation source. Both the heat and the second radiation source initiate cure of the deposited layer of prepreg. It is also preferred that any underlying layer of prepreg onto which the deposited prepreg is placed is also heated to ensure good consolidation between subsequent layers. Preferably the second radiation/and or heat radiation also penetrates to the underlying prepreg layers to further cure of the underlying prepreg. Thus the top-most layer and underlying layers of prepreg are cured at least partially simultaneously during the deposition of the top most layer of prepreg. This ensures good consolidation between layers and improves the intra laminar shear strength between plies.

The heat and/or second radiation can be applied before, during or shortly after deposition of the prepreg. Preferably heat or IR radiation is applied to the top side and/or underside of the prepreg prior to deposition to reduce viscosity of the prepreg so as to achieve good tack to aid deposition and to lower the resin viscosity to increase resin flow, improving consolidation. Preferably the underlying layer of prepreg is also heated prior to increase its tack prior to deposition of a layer of prepreg onto it.

We have found that the temperature of the deposited prepreg can be in the range of from 20 to 90° C., preferably from 30 to 80° C., more preferably from 40 to 70° C. and most preferably from 40 to 55° C. For these temperatures, a photoinitiator accelerates the cure of the prepreg resulting in an overall optimised cure in which the green strength of the prepreg is reached faster than if the prepreg were cured using either heat or a photoinitiator alone. If the temperatures are increased beyond the aforesaid ranges, than cure of the prepreg is entirely controlled by the temperature and this does not result in a reduction of the time to cure the prepreg to green strength.

In an embodiment of the present invention, pressure is applied to the topside of the prepreg as it is deposited. This may for example be applied with a compaction device such as a shoe or roller if the prepreg is deposited using AFP or ATL apparatus. The application of pressure during deposition further consolidates the prepreg layer to the underlying layers and reduces porosity by driving voids out of the interply region. Preferably the compaction device is attached to the deposition apparatus and is operated simultaneously. Preferably the compaction device also provides heat to the prepreg.

In a preferred embodiment of the present invention, lengths of single plies of prepreg are deposited by ATL or AFP which moves across the mould surface. As these plies are deposited, heat, infra-red or other radiation sources mounted on or nearby the ATL apparatus at least partially cure prepreg as it is deposited. Because deposition and partial cure occur in the same process, the entire layup does not require heating or heating is limited, and this results in energy savings. It also ensures that each length of prepreg in the layup receives the same extent of cure ensuring uniform properties across the final cured part.

In a preferred embodiment of the present invention, prepregs are deposited and partially cured until the lay-up has achieved sufficient strength to be demoulded. At this point the lay-up can be transferred to an oven for complete cure at a reduced energy input whilst another lay-up is deposited in the mould. This increases the production rate that can be obtained from a single mould.

Another advantage of the present invention is that because heat and a second source of radiation are applied directly to the prepreg as it is deposited, the mould need not be configured to withstand high oven temperatures. Therefore a lower temperature mould can be used substantially reducing the mould cost.

With vacuum bagged prepregs or infused fibres a certain amount of resin is bled from the structure during cure. This means the shape of the finished article is different from the shape of the lay-up. This change results in internal stresses and presents difficulties when trying to accurately produce articles. The present invention overcomes this because the prepregs are at least partially cured as they are deposited, they do not suffer from resin bleed. Therefore the volume of a lay-up according to the present invention exhibits minimal shape change during cure, and articles made to the invention retain a near net shape.

In an embodiment of the present invention, the prepreg is deposited and sufficiently partly cured by heat and radiation from the apparatus to such an extent that the combined effects of the heat and consolidation device being used on the next overlying layer of prepreg does not cause the under lying layer of prepreg to be moved from the position in which it was deposited. In order to achieve this it is necessary to provide a rapid curing matrix.

Preferably the deposited pregreg is at least partly cured by the apparatus to an extent of at least 50%, preferably 80% (measured by differential scanning calorimetry (DSC)) to achieve ‘green strength’, which is the term used to describe a composite structure having at least sufficient strength to be demoulded. A method of determining the heat of reaction and the rate of cure as well as the level or extent of cure using DSC are described in the paper Heat of reaction, degree of cure, and viscosity of Hercules 3501-6 resin, Lee W I et al., J Composite Materials, Vol. 16, p 150, November 1982.

In order for the process to achieve improved production rate, the rate of deposition and at least partial cure of the prepreg needs to be at least 5 mm/s, preferably 10 mm/s, more preferably 25 mm/s or 50 mm/s. Preferably at least 150 mm/s and more preferably still at least 250 mm/s.

In a preferred embodiment of the present invention the prepreg contains more than one UV photoinitiated curing agent each initiated by different wavelengths. Preferably the prepreg has at least two photoinitiators. The use of more than one photo initiated curing agent allows for increased cure rate and a greater control over the rate of cure, by applying different frequencies of radiation at different times. In an alternative embodiment the apparatus of the present invention comprises a radiation source capable of providing radiation at multiple peak wavelengths. Alternatively an array of different radiation sources each with different peak wavelengths.

The prepreg or resin formulation may comprise one or more photoinitiators which may be selected from alkyl sulphonium salts, alkyl iodonium salts, sulphonium salts which may comprise fluorophosphate and/or fluoroanitmonate. The photonitiators may be selected from the following salts: triaryl Sulphonium hexafluoroantimonate, diaryl lodonium hexaflurorantimonate, diaryl lodonium hexaflurorantimonate, triaryl Sulphonium hexafluorophosphate, triaryl Sulphonium BF4, triaryl Sulphonium hexafluorophosphate, diaryl lodonium hexaflurorophosphate, and/or thioxanthone modified sulphonium. These salts may be present in a solvent which may be selected from propylene carbonate and glycidyl ether.

The photoinitiator may be present in the range of from 0.25 to 10 weight %, more preferably from 0.4 to 8 weight %, even more preferably from 0.5 to 6 weight %, and even more preferably from 0.75 to 5 weight %, or preferably from 0.5 to 4 weight % or from preferably from 0.9 to 3 weight % or from 1 to 2 weight % or from 1.5 to 2.5 weight % based on the total weight of the formulation and/or combinations of the aforesaid ranges.

The prepreg or resin formulation may further comprise one or more accelerators which may be selected from triethylenglycol divinyl ether, cyclohexane dimethanol, hydroxybutyl vinyl ether, cyclohexyl vinyl ether, trmethyolpropane oxetane, dendritic polyester polyol, polyether diol, polycaprolactone triol, aliphatic epoxy and dipentaerythritol penta/hexa acrylate. We have found that each of these accelerators can enhance the cure of an epoxy based resin formulation which comprises at least one photoinitiator, and particularly a photoinitiator as described in this application.

The accelerator may be present in the range of from 0.25 to 10 weight %, more preferably from 0.4 to 8 weight %, even more preferably from 0.5 to 6 weight %, and even more preferably from 0.75 to 5 weight %, or preferably from 0.5 to 4 weight % or from preferably from 0.9 to 3 weight % or from 1 to 2 weight % or from 1.5 to 2.5 weight % based on the total weight of the formulation and/or combinations of the aforesaid ranges.

The fibrous materials used with the resin formulations that are used in this invention may be tows of carbon fibre, glass fibre or aramid; a tow being a strand made up of a plurality of fibres or filaments.

The fibres or filaments used in this invention may be glass and/or carbon fibres, carbon fibre being particularly preferred in the manufacture of wind turbine shells of length above 40 metres such as from 50 to 60 metres. The tows are made up of a multiplicity of individual fibres and preferably are unidirectional. Typically the tows will have a circular or almost circular cross-section with a diameter in the range of from 3 to 20 μm, preferably from 5 to 12 μm. Different fibres may be used in different prepregs used to produce a cured laminate.

Exemplary tows are HexTow® carbon fibres, which are available from Hexcel Corporation. Suitable HexTow® carbon fibres include: IM7 carbon fibres, which are available as fibres that contain 6,000 or 12,000 filaments and have a weight of 0.223 g/m and 0.446 g/m respectively; IM8-IM10 carbon fibres, which are available as fibres that contain 12,000 filaments and weigh from 0.446 g/m to 0.324 g/m; and AS7 carbon fibres, which are available in fibres that contain 12,000 filaments and weigh 0.800 g/m. Other useful materials include Panex 35, Mitsubishi TRH50 or Toray T300, T700 or T800.

The present invention is particularly useful in the production of wind turbine blades. As wind turbine blades increase in size, their manufacture requires stacks of multiple layers of composite fibre and resin reinforcement. Conventionally, resin preimpregnated fibrous reinforcement (prepreg) is laid up in a mould to form these stacks.

The resin used in this invention is a mixture of liquid and solid epoxy resins. The solid epoxy resin may be solid or what is known in the art as semi solid. The reactivity of an epoxy resin is indicated by its epoxy equivalent weight (EEW) the lower the EEW the higher the reactivity. The epoxy equivalent weight can be calculated as follows: (Molecular weight epoxy resin)/(Number of epoxy groups per molecule). Another way is to calculate with epoxy number that can be defined as follows: Epoxy number=100/epoxy eq.weight. To calculate epoxy groups per molecule: (Epoxy number×mol.weight)/100. To calculate mol.weight: (100×epoxy groups per molecule)/epoxy number. To calculate mol.weight: epoxy eq.weight×epoxy groups per molecule.

The liquid epoxy resin used in this invention preferably has a high reactivity as indicated by an EEW in the range from 50 to 500 preferably a high reactivity such as an EEW in the range 50 to 250 and the solid epoxy resin preferably has an EEW in the range 300 to 1500. The resin composition comprises the epoxy resin mixture and a photoinitiator optionally together with an accelerator. The solid/semi solid and liquid epoxy resins may comprise blends of two or more epoxy resins selected from monofunctional, difunctional, trifunctional, tetrafunctional epoxy resins and/or any epoxy resin with a functionality greater than or equal to two. Suitable difunctional epoxy resins, by way of example, include those based on: diglycidyl ether of bisphenol F, diglycidyl ether of bisphenol A (optionally brominated), phenol and cresol epoxy novolacs, glycidyl ethers of phenol-aldelyde adducts, glycidyl ethers of aliphatic diols, diglycidyl ether, diethylene glycol diglycidyl ether, aromatic epoxy resins, aliphatic polyglycidyl ethers, epoxidised olefins, brominated resins, aromatic glycidyl amines, heterocyclic glycidyl imidines and amides, glycidyl ethers, fluorinated epoxy resins, glycidyl esters or any combination thereof.

Difunctional epoxy resins may be selected from diglycidyl ether of bisphenol F, diglycidyl ether of bisphenol A, diglycidyl dihydroxy naphthalene, or any combination thereof.

Suitable trifunctional epoxy resins, by way of example, may include those based upon phenol and cresol epoxy novolacs, glycidyl ethers of phenol-aldehyde adducts, aromatic epoxy resins, aliphatic triglycidyl ethers, dialiphatic triglycidyl ethers, aliphatic polyglycidyl amines, heterocyclic glycidyl imidines and amides, glycidyl ethers, fluorinated epoxy resins, or any combination thereof. Suitable trifunctional epoxy resins are available from Huntsman Advanced Materials (Monthey, Switzerland) under the tradenames MY0500 and MY0510 (triglycidyl para-aminophenol) and MY0600 and MY0610 (triglycidyl meta-aminophenol). Triglycidyl meta-aminophenol is also available from Sumitomo Chemical Co. (Osaka, Japan) under the tradename ELM-120.

Suitable tetrafunctional epoxy resins include N,N, N′,N′-tetraglycidyl-m-xylenediamine (available commercially from Mitsubishi Gas Chemical Company under the name Tetrad-X, and as Erisys GA-240 from CVC Chemicals), and N,N,N′,N′-tetraglycidylmethylenedianiline (e.g. MY0720 and MY0721 from Huntsman Advanced Materials). Other suitable multifunctional epoxy resins include DEN438 (from Dow Chemicals, Midland, Mich.) DEN439 (from Dow Chemicals), Araldite ECN 1273 (from Huntsman Advanced Materials), and Araldite ECN 1299 (from Huntsman Advanced Materials).

We have found that a mixture of semi-solid epoxy resins mixed with a liquid resin is particularly useful especially if the prepreg is laid up automatically where the viscosity of the prepreg is important to allow ready lay-up of the prepreg.

The prepregs are typically used at a different location from where they are manufactured and they therefore require handleability. It is therefore preferred that they are dry or as dry as possible and have low surface tack. It is therefore preferred to use high viscosity resins. This also has the benefit that the impregnation of the fibrous layer is slow allowing air to escape and to minimise void formation. Additionally the prepregs may be partially cured by photoinitiation in one location and transported to another location where cure is completed

The photoinitiator in the formulation that is used according to the present invention will be selected according to the nature of the curable resin that is used in the formulation. We have found that alkyl sulphonium salts such as CPI 6975 supplied by Esstech Inc are particularly useful photoinitators which can be used to impart at least partial cure to an epoxy resin within a prepreg when subjected to ultra violet light. We have found that from 0.2 to 10 wt % preferably from 3 to 8 wt % more preferably from 4 to 6 wt % of the photoinitator based on the weight of the resin formulation should be used. The formulation may also contain a catalyst for the photoinitiator such as the product UV 9390 supplied by Momentive under the trade name Silfone. We have found that the use of from 10 to 30% of the catalyst based on the weight of the photoinitiator preferably from 15 to 25 wt % is particularly suitable.

The resin formulation may contain a thermally activatable curing agent in addition to the photoinitiator which can be activated subsequent to the partial cure provided by the photoactivation of the photoinitiator. Accordingly the prepreg may be laid up in the mould subject to photoinitiation to cause partial cure of the resin and the final cure may then be achieved by heating the partially cured prepreg. The final thermal cure may be accomplished in line with the photocure or may be accomplished at a separate location.

The prepreg may be preferentially designed, including by doping with compounds or elements that have increased absorption or reaction characteristics in response to particular radiation wavelengths or wavelength bands that are emitted by pulsed or non-pulsed radiation sources. As a further example, the composite material may be coated with a surface layer of an alternative material that preferentially absorbs or reflects particular wavelengths or wavelength bands that are emitted by pulsed radiation sources.

In an automated process using a resin formulation according to the invention the prepreg may be fed to the mould by an ATL or AFP apparatus. ATL of AFP apparatus typically comprise an automated robotic arm or gantry which supports a head capable of depositing strips of prepreg of a specified length onto a surface. For example, the ATL or AFP apparatus may be provided with a head comprising a chute into which pre-cut sections of prepreg are fed or lengths are cut by the apparatus, this chute can then direct sections of the prepreg under a compaction roller which can adhere the prepreg to a substrate and the robot can then pull the prepreg past an array providing radiation and or heat typically by moving the automated head.

In other embodiments, the array may not be carried by a head that lays tows. For example, the array may without limitation be carried by a different robotic arm or other arrangement, which ensures that appropriate heating of the heating region is achieved. In addition, or alternatively, a system may have a bed on which a tool or previously laid layers of composite material rest, and the bed may be arranged to move relative to a static head, or each of the head and bed may be arranged to move relative to one another, for example, along the same axis (e.g. the X-axis) of movement. In other words, embodiments of the present invention accommodate, in general terms and without limitation, a head (or other arrangement that carries the pulsed radiation source) and tool or previously-laid layers of composite material (or layers about to be laid onto a tool or previously-laid layers) being arranged to move relative to one another by any suitable means

The array can provide IR, UV, Electron-beam, Microwave or radio frequency radiation to induce or accelerate cure. Preferably UV radiation is used, more preferably radiation having a wavelength between 350 and 440 nm, or more preferably still 360 to 400 nm, most preferably from 365 to 395 nm. The radiation source causes partial curing of the prepreg as it adheres to the tool, or the previous ply. The robot may be provided with a shoe which may be heated and once partial cure has been accomplished the robot head may continue to move in either the X or Y axis, or a combination thereof, to consolidate the laid down and partially cured prepreg.

The array may comprise a single flashlamp/heat lamp or plural flashlamps/heat lamps, for example, arranged in a two or three-dimensional arrangement. The array may be mounted on a gantry or robot arm above the mould. Where there are plural flashlamps, if they provide pulsed radiation or heat they may be controlled to flash substantially simultaneously (that is, at or near enough at the same time as each other in the context of the manufacturing speeds being employed and the heating and cooling profiles that are desired) or in a time-delayed (e.g. staggered) manner. Alternatively, each of the plural flashlamps may have an independent control system and be arranged to flash when required to attain a pre-determined heating profile on the contact surface of previously laid layers or a mould. Such an arrangement may be employed, for example, in a process of the invention in which layers of prepreg are laid as part of an AFP, ATL or other automated system. In this (and in all other embodiments), a distance between the array and the contact surface to be heated may be controlled along a second axis (Y-axis), thereby to increase control over heating.

In alternative embodiments (not illustrated herein), an array could be mounted below in addition to or instead of above a contact surface to be heated. For example, by arranging an array above and below (or, more generally, on either side) of one or more layers of composite material forming a composite structure, it would be possible to heat both respective contact surfaces substantially simultaneously, for example, to increase tack on both sides before deposition. This arrangement could, for example, find beneficial application in systems in which fresh layers or tows are laid substantially simultaneously onto both sides of an existing composite structure. Further, using arrays to heat both sides of an existing composite structure could be employed to heat through the bulk material more quickly and evenly. This, for example, may be desirable in hot-forming applications. An array can also be used to heat deposited prepreg to increase tack before a subsequent layer is deposited onto it.

Prepreg comprises both fibre and matrix component materials. Each of these component materials may absorb and heat differently for a given wavelength range. Such disparate and uneven heating characteristics may not be desirable in some scenarios. According to some embodiments of the present invention, a heat source is selected that has plural output radiation peaks, which substantially correspond to radiation absorption peaks of each of the component materials. In this way, each of the component materials can be heated according to a similar heating profile (that is, temperature increase against time). This may achieve a more consistent and efficient heating profile for the prepreg as a whole. In other embodiments, a flashlamp is selected to have a relatively flat, (e.g. substantially continuum) radiation spectrum which encompasses radiation absorption peaks of each of the component materials, thereby having a similarly efficient heating profile for each component material.

Unidirectional laminates, and multi-axial panels that mimic materials such as Hexcel products LBB1200 (0°, 0°, +45°, −45°) have been produced by UV photoinitation and have been subjected to a range of testing; for example DMA has been used to establish a cured Tg for the material. Samples have displayed E′ (or loss modulus as measured using DMA (dynamic mechanical analysis)), Tg's between 90-120° C. are without requiring any post cure.

The process of the invention is highly tailorable, with many possible parameters that can be modified giving enhanced automated control over properties, product shape, and fibre orientation. Parameters including shoe temperature, shoe pressure, compaction roller temperature, distance of UV lamp from the prepreg, speed of robot movement, as well as a number of additional passes of UV light allowing for final and full cure can be varied according to the nature of the prepreg and the nature of the finished article to be produced.

If the article is to have a final thermal cure, the epoxy resin composition may also comprise one or conventional non-radiation activated curing agents. These can be selected from aliphatic or aromatic amines or their respective adducts, amidoamines, polyamides, cycloaliphatic amines, anhydrides, polycarboxylic polyesters, isocyanates, phenol-based resins (e.g., phenol or cresol novolak resins, copolymers such as those of phenol terpene, polyvinyl phenol, or bisphenol-A formaldehyde copolymers, bishydroxyphenyl alkanes or the like), dihydrazides, sulfonamides, sulfones such as diamino diphenyl sulfone, anhydrides, mercaptans, imidazoles, ureas, tertiary amines, BF3 complexes or mixtures thereof. Particular preferred curing agents include modified and unmodified polyamines or polyamides such as triethylenetetramine, diethylenetriamine tetraethylenepentamine, cyanoguanidine, dicyandiamides and the like. Particularly preferred curing agents are those that are encapsulated so as to prevent them from poisoning the cationic cure from the radiation initiated curing agent, one such example of a particularly suited encapsulated curing agent is TEP (1,1,2,2-Tetrakis(p-hydroxyphenyl)ethane).

It is preferred to use from 0.5 to 10 wt % based on the weight of the epoxy resin of a curing agent, more preferably 1 to 8 wt %, more preferably 2 to 8 wt %, more preferably 0.5 to 5 wt %, more preferably 0.5 to 4 wt % inclusive, or most preferably 1.3 to 4 wt % inclusive.

When used the urea curing agent may comprise a bis urea curing agent, such as 2,4 toluene bis dimethyl urea or 2,6 toluene bis dimethyl urea and/or combinations of the aforesaid curing agents. Urea based curing agents may also be referred to as “urones”.

Preferred urea based materials are the range of materials available under the commercial name DYHARD® the trademark of Alzchem, urea derivatives, which include bis ureas such as UR500 and UR505.

When used the thermally activated curing agent should preferably have an onset temperature in the range of from 115 to 125° C., and/or a peak temperature in the range of from 140 to 150° C., and an enthalpy in the range of from 80 to 120 J/g (Tonset, Tpeak and. Onset temperature is defined as the temperature at which curing of the resin occurs during the differential scanning calorimetry (DSC) scan, whilst peak temperature is the peak temperature during curing of the resin during a (DSC) scan. Typically these are measured by DSC in accordance with ISO 11357, over temperatures of from −40 to 270° C. at 10° C./min).

In an embodiment of the present invention, the heat source and second radiation source may be provided by the same apparatus. In alternative embodiments both the heat and the second source of radiation may be provided as continuous or pulsed radiation.

The heat or radiation source according to embodiments of the present invention can employ a pulsed electromagnetic radiation source (or simply a ‘pulsed radiation source’). As will be described, some embodiments of the present invention employ a Xenon flashlamp of generally known kind, which can emit a relatively broadband radiation spectrum including one or more of IR, visible light and ultra-violet (UV) radiation components. Unless otherwise indicated, the terms ‘flash’ and ‘pulse’ will be used interchangeably herein at least in respect of flashlamp embodiments. In general terms, however, any other suitable pulsed or non-pulsed radiation source may be employed according to alternative embodiments of the invention. For example, according to some embodiments, a pulsed laser source may be employed.

As used herein, a flashlamp is a type of electric arc lamp designed to provide short pulses (or flashes) of high energy, incoherent radiation with a relatively wide spectral content. Flashlamps have been used in photographic applications, as well as in a number of scientific, industrial and medical applications. The use of a pulsed radiation system, rather than a continuous heating system, opens up a number of new options for controlling heating temperature, as will be described herein. For the heating of contact surfaces herein, the process may be optimised by adjusting one or more of a number of system parameters, including but not limited to: the number of pulses, pulse width (or flash duration), pulse intensity and pulse frequency. As will be described, shaped or 3D reflectors can also be employed to focus and control the direction of emitted radiation. Appropriate 3D reflectors may comprise flat, singly curved or doubly curved surfaces.

Xenon flashlamps are particular suited for use as a heat source with the present invention, they are capable of heating contact surfaces, for example of composite material samples, very quickly, consistently and controllably, typically exceeding the performance of other heat sources, such as known IR heat sources. Moreover, after a pulse, gasses cool relatively quickly—that is, they retain less residual heat than filament-based heaters (after ‘switch-off)—which means flashlamps afford far greater control over heating and cooling speed during operation, compared with filament-based heaters, and may obviate entirely supplemental heating and cooling sub-systems that are taught in the prior art. This greater heating and cooling control capability also supports increased manufacturing speeds, for example, whereby relative speeds between a heater and a contact surface being heated can be increased.

A sequence of pulses (flashes) in quick succession can be employed to raise the surface temperature of a layer of prepreg (or any other contact surface, such as a tool) in an extremely controlled manner. The temperature can be controlled, for example, according to the number of pulses and the time between pulses, which, in the illustrative example shown, is one pulse approximately every five seconds. Higher and lower pulse frequencies can of course be employed depending on the heating profile required. Once the surface has reached a target temperature, the time between pulses can be increased to maintain the desired temperature. Of course, other pulse parameters, such as pulse intensity, may be modified instead of or in addition to pulse frequency in order to control and maintain target temperatures.

Multiple pulses can be used to achieve and then maintain a target temperature. The combination of fast heating (during the pulses) and relatively slow cooling (between the pulses) provides a novel method of temperature control during the manufacture of composite articles. For example, according to embodiments of the present invention, as the surface temperature varies between the higher peaks and the lower cooling areas, the time delay between heating the surfaces and bringing the surfaces together may be varied to target the optimal temperature for the process. Consequently, advantage can be taken of the surface temperature peaks, without having to heat the bulk of a material to that high temperature.

In further alternative embodiments of the invention, plural flashlamps (or other radiation sources) may be mounted and arranged to heat substantially simultaneously both unlaid and previously laid layers of prepreg. Of course, one or more flashlamps (or other radiation sources) may instead or in addition be mounted and arranged to heat any other element or surface of the system, as the need dictates.

The radiation source output can be controlled according to a required head speed—that is, the speed the head moves across the tool or previously laid tows—to reach and maintain a target temperature and extent of cure. In particular, as head speed is increased the output of radiation is increased as well (or vice versa). The degree of heating and cure may in addition, or alternatively, be controlled by varying at least one of the distance of the source(s) from the contact surface and the angle of the incident radiation in relation to the prepreg's surface. In addition (or alternatively) a radiation filter may be placed between the source and contact surface. Such a filter may be formed as part of the source itself or as an intermediate structure between the source and the contact surface being heated.

Preferred UV sources are UV LEDS providing radiation of wavelength between 340 and 430 nm. Exemplary UV sources include Phoseon® Fireline LED UV lamps and Heraeus Noblelight Fusion UV F300s. Preferred wavelengths may be selected from 365 nm and 395 nm.

The structural fibres employed in the prepregs may be in the form of random, knitted, non-woven, multi-axial fibres or any other suitable pattern. For structural applications, it is generally preferred that the fibres be unidirectional in orientation. When unidirectional fibre layers are used, the orientation of the fibre can vary throughout the prepreg stack. However, this is only one of many possible orientations for stacks of unidirectional fibre layers. For example, unidirectional fibres in neighbouring layers may be arranged orthogonal to each other in a so-called 0/90 arrangement, which signifies the angles between neighbouring fibre layers. Other arrangements, such as 0/+45/−45/90 are of course possible, among many other arrangements.

The structural fibres may comprise cracked (i.e. stretch-broken), selectively discontinuous or continuous fibres. The structural fibres may be made from a wide variety of materials, such as carbon, graphite, glass, metalized polymers, aramid and mixtures thereof. Glass and carbon fibres are preferred, carbon fibre being preferred for wind turbine shells of length above 40 metres such as from 50 to 60 metres. The structural fibres, may be individual tows made up of a multiplicity of individual fibres and they may be woven or non-woven fabrics. The fibres may be unidirectional, bidirectional or multidirectional according to the properties required in the final laminate. Typically the fibres will have a circular or almost circular cross-section with a diameter in the range of from 3 to 20 μm, preferably from 5 to 12 μm. Different fibres may be used in different prepregs used to produce a cured laminate.

The structural fibres of the prepregs will be substantially impregnated with the epoxy resin and prepregs with a resin content of from 20 to 45 wt %, preferably 28 to 40 wt %, and more preferably from 30 to 38 wt % based on the total prepreg weight.

Upon curing, the stack becomes a composite laminate, suitable for use in a structural application, such as for example an automotive, marine vehicle or an aerospace structure or a wind turbine structure such as a shell for a blade or a spar. Such composite laminates can comprise structural fibres at a level of from 80% to 15% by volume, preferably from 58% to 65% by volume.

The invention has applicability in the production of a wide variety of materials. One particular use is in the production of wind turbine blades. Typical wind turbine blades comprise two long shells which come together to form the outer surface of the blade and a supporting spar within the blade and which extends at least partially along the length of the blade. The length and shape of the shells vary but the trend is to use longer blades (requiring longer shells) which in turn can require thicker shells and a special sequence of materials within the stack to be cured. This imposes special requirements on the materials from which they are prepared. Carbon fibre based prepregs are preferred for blades of length 30 metres or more, particularly those of length 40 metres or more such as 45 to 65 metres whilst the dry fibre is preferably a glass fibre. The length and shape of the shells may also lead to the use of different prepregs/dry fibre materials within the stack from which the shells are produced and may also lead to the use of different prepregs/dry fibre combinations along the length of the shell.

The invention is illustrated by way of example only and with reference to the following Example.

The following formulation was prepared.

| | |
|---|---|
| Semi-solid bisphenol A epoxy resin LY1589 | 92.0% |
| Liquid epoxy resin of EEW 175-205 DER 736 | 1.5% |
| Mixed amyl sulphonic salt Photoinitiator | 5.5% |
| CPI 6976 | |
| Catalyst UV 9390 | 1.0% |
| total | 100.0% by weight |
| | of formulation |

The formulation was mixed in a 10 L Winkworth mixer, and then filmed into two 65 gsm films, which were in turn impregnated into Ahlstrom R344 glass fibre with a nominal fibre aerial weight of 300 gsm. The prepregs were cut to size and then cured.

The cure process used a Fanuc Mi16B/20 robot, with a robotic head comprising a chute into which the pre-cut prepreg was fed. This chute directs the prepreg under a compaction roller which causes the prepreg to adhere to the substrate and then pulled the prepreg past a UV array by moving the robot head. The UV array provided UV radiation at 395 nm at an intensity of 15 W/cm² measured using a Dymax LED/UV radiometer. The UV source allowed partial curing of the prepreg at a curing rate of approximately 15 mm/s which equates to 2.3 kg/h.

Panels were manufactured by laying down multiple piles in any direction.

The panels were also subjected to microscopic analysis for void content. Void content of laminates of the invention was less than <1% which is comparable with current hand lay-up processes.

The unidirectional panels of 10 ply thickness were subjected to ILSS (interlaminar shear strength) testing (in accordance with ASTM EN2563) providing values of >30 MPa, using a Fanuc Mi16B/20 with a shoe temperature of 200° C., shoe pressure of 5 Bar, 100% UV intensity (395 nm), with the robot set to move at a rate of 15 mm/s.

Unidirectional panels 10 plies thick have been produced and subjected to inter-laminar shear strength testing providing values of >30 MPa, using a shoe temperature of 200° C., shoe consolidation pressure of 5 Bar, employing 100% UV intensity (395 nm) for cure, with the robot head set to move at a rate of 15 mm/s. A triaxial ‘like’ panel was also tested for ILSS, returning an average value of 39.1 MPa, this panel was also tested for flexural strength and modulus returning average values of 660 MPa and 28 GPa respectively. These results indicate that the properties of the experimental photocured materials are close to the strength of commercially available systems produced by thermal cure in ovens.

### EXAMPLE 6

In this example the components are as follows.

LY1589 bisphenol A epoxy resin (Huntsman)
TASHFP triaryl sulphonium hexafluorophosphate (50% by weight in solution in propylene carbonate)
TASHFA triaryl sulphonium hexfluoroantimonate (50% by weight in solution in propylene carbonate)

A formulation is prepared using the following formulations:

TABLE 1

| | 6a | 6b | 6c | 6d | 6e | 6f | 6g | 6h | 6i |
|---|---|---|---|---|---|---|---|---|---|
| Component | (wt %) | (wt %) | (wt %) | (wt %) | (wt %) | (wt %) | (wt %) | (wt %) | (wt %) |
| LY1589 | 97 | 98 | 99 | 96 | 94 | 95 | 99.5 | 99 | 99.5 |
| TASHFP | 3 | 2 | — | — | — | — | | 1 | .5 |
| TASHFA | — | — | 1 | 4 | 6 | 5 | .5 | | |

These formulations were analysed using differential scanning calorimetry (DSC, using a PerkinElmer DSC6000) and dielectric analysis (DEA, using a Nietzsche DEA 288 Epsilon) to measure the heat of reaction and the rate of cure as well as the level or extent of cure using the method described in the paper Heat of reaction, degree of cure, and viscosity of Hercules 3501-6 resin, Lee W I et al., J Composite Materials, Vol. 16, p 150, November 1982. In addition, the glass transition temperature (T_{g}) in accordance with ASTM E1356 and the enthalpy and transition temperatures were determined in accordance with ASTM3418 and ASTM E2038 and E2039.

The results are presented in below Table 2.

TABLE 2

| | Total | Enthalpy | Time to | Peak | Time to | Maximum |
|---|---|---|---|---|---|---|
| | enthalpy | 80% cure | 80% cure | enthalpy | Peak | cure rate |
| Formulation | (J/g) | (J/g) | (mins) | (W/g) | (mins) | (W/g/min) |
| 6a | 196 | 157 | .5 | 19 | .1 | 842 |
| 6b | 209 | | | | | 1403 |
| 6c | 206 | | .4 | | | 818 |
| 6d | 185 | | .6 | | | 292 |
| 6e | 187 | | .9 | | | 290 |
| 6f | 192 | | .7 | | | |
| 6g | 186 | | .6 | | | 629 |
| 6h | 212 | | .6 | | | 970 |
| 6i | 199 | | .9 | | | 726 |

The formulation of Example 6c provides an advantageous time to cure to 80% of 0.4 mins whilst the maximum rate of cure is of a desired level to allow thermal management of the exotherm heat release in lay-ups containing multiple prepreg layers.

The formulation of Example 6c was used to impregnate a unidirectional glass fiber reinforcement material of 2400 tex fiber tows and of 600 g/m² weight. Lay-ups were prepared from 4 layers of this prepreg material.

The lay-ups were subjected to the following cure schedule. Each formulation was heated to 50° C. and a light source producing light at a wavelength of 365 nm with an output of 8 W/cm². The material was exposed to the light source at varying speeds as follows: 5 mm/s, 12.5 mm/s, 25 mm/s, 37.5 mm/s and 50 mm/s. We found that the lay-ups can be fully cured for processing speeds up to 25 mm/s in a single pass.

1. A process for producing a composite article comprising the steps of:
a) depositing a prepreg containing a radiation initiated curing agent onto a mould; and
b) applying heat and second source radiation to at least partially cure the prepreg at least simultaneously with deposition of the prepreg.

2. A process according to claim 1 wherein said radiation initiated curing agent comprises at least two initiators configured to be initiated at different frequencies of radiation.

3. A process according to claim 1 wherein said second source radiation is ultra violet radiation.

4. A process according to claim 1 wherein heat is applied using infra-red lamps or xenon bulbs.

5. A process according to claim 1 wherein pressure is applied to the prepreg during deposition.

6. A process according to claim 1 wherein the composite article is partially cured and then demoulded.

7. A process according claim 6 comprising the additional step of completing cure of the demoulded composite article in an oven.

8. A process according to claim 1 for the production of wind turbine blades.

9. A prepreg capable of at least partial cure without the use of an oven, comprising a resin and a fibrous material impregnated with the resin, the resin comprising a mixture of a liquid epoxy resin, a solid epoxy resin and at least one radical photoinitiator and a radical (photo) cure accelerator.

10. A prepreg according to claim 9 wherein the resin further comprises an encapsulated amine curative.

11. A prepreg according to claim 9 in which the fibrous material comprises carbon fibre, glass fibre or aramid fibre.

12. (canceled)

13. A prepreg according to claim 9 in which the liquid epoxy resin has an epoxy equivalent weight in the range of from 50 to 500.

14. (canceled)

15. (canceled)

16. A prepreg according to claim 9 in which the photoinitiator is selected from the group consisting of alkyl sulphonium salts, alkyl iodonium salts, sulphonium salts comprising fluorophosphates and fluoroanitmonate.

17. A prepreg according to claim 9 in which the photoinitiator is present in an amount from 0.25 to 10 wt % based on the weight of the resin.

18. A prepreg according to claim 9 in which the resin contains a thermally activatable curing agent such as a polycyandiamide, a urea based curing agent or an imidazole.

19. (canceled)

20. An automated tape laying apparatus for automated deposition and simultaneous partial cure of prepreg, the apparatus comprising a compaction device, a heat source, and a second radiation source.

21. An automated tape laying apparatus according to claim 20 wherein the second radiation source is an ultra violet source.

22. An automated tape laying apparatus according to claim 21 wherein the ultra violet source comprises an array of sources configured to provide ultraviolet radiation at two or more target frequencies.

23. An automated tape laying apparatus according to claim 20 wherein the compaction device comprises a heated shoe.

24. (canceled)

25. (canceled)

26. (canceled)
